(19) United States
(12) Patent Application Publication
(10) Pub. No.: US 2018/0115105 A1
(43) Pub. Date: Apr. 26, 2018

(54) TRANSMISSION LINE, IN PARTICULAR OF RIGID TYPE AND FOR RADIOFREQUENCY POWER APPLICATION

(71) Applicant: ONETASTIC S.R.L., Brescia (BS) (IT)

(72) Inventor: Carlo Bombelli, Roncadelle (IT)

(73) Assignee: ONETASTIC S.R.L.

(21) Appl. No.: 15/786,955

(22) Filed: Oct. 18, 2017

(30) Foreign Application Priority Data
Oct. 24, 2016 (IT) 102016000107038

(51) Int. Cl. H01R 13/627; H01R 24/56; H01R 24/42

(52) U.S. Cl. CPC H01R 13/627; H01R 2103/00; H01R 24/42; H01R 24/56

(57) ABSTRACT

A transmission line, in particular of the rigid type and for a radiofrequency power application, includes: a first conductor having a tubular shape; a second conductor, concentrically and coaxially positioned inside said first conductor; a dielectric, in particular consisting of air, positioned between the first conductor and the second conductor; a connector having a body adapted to be coupled to a terminal tract of the first conductor, wherein the connector includes at least one first connection element adapted to be inserted, at least partially, into a seat formed in one end of the second conductor, in particular the at least one first connection element including a substantially tubular first portion from which a plurality of first elastic tabs extend. The second conductor includes a second connection element at least partially positioned in the seat, the second connection element being adapted to be coupled to the first connection element by inserting it into a cavity of the first connection element.

### 1. THE FIELD OF THE INVENTION

The present invention relates to a transmission line, in particular of the rigid type and for a radiofrequency power application, according to the preamble of claim 1.

### 2. THE RELEVANT TECHNOLOGY

It is known in the art that a transmission line, in particular of the rigid type and for radiofrequency power applications, is so designed as to comprise a first conductor (also known as “outer conductor”) having a tubular shape, a second conductor (also known as “inner conductor”) concentrically and coaxially positioned inside said first conductor, and a dielectric positioned between the first conductor (outer conductor) and the second conductor (inner conductor).

In particular, the dielectric positioned between the first conductor and the second conductor may consist of air or gas.

In such a case, preference is given to air, e.g., as used in television broadcasting applications, for the purpose of allowing for fast on-site assembly of the rigid transmission line without requiring subsequent filling of the system with a specific gas.

In order to obtain a desired length of said transmission line, it is known in the art to couple together a plurality of sections of a rigid transmission line by means of a junction comprising a connector associated with at least one end of the transmission line.

In particular, the junction connector is so designed as to comprise a body adapted to be coupled to a terminal tract of the outer conductor, and comprises at least one connection element adapted to be inserted, at least partially, into a seat formed in one end of the inner conductor; in its turn, the connection element comprises a substantially tubular portion from which a plurality of elastic tabs extend.

In accordance with one implementation, the junction connector is so designed as to comprise a casing typically having a cylindrical (sleeve-like) shape, in particular said casing having an inside diameter that makes the ends thereof suitable for being coupled to one end of the outer conductor. In such an implementation, said casing is typically made of metallic materials.

Furthermore, the connector casing is associated with a body (also referred to as “spacer” or “rigid centralizer”) having a substantially discoid (flange-like) shape, which allows the connection element to be positioned coaxially within the casing and the inner connection element to be insulated from said casing. Said body or spacer is preferably made of non-conductive material, in particular plastic material (e.g., polytetrafluoroethylene, also known as “PTFE”, i.e., a polymer of tetrafluoroethylene commercially known as TEFLON® or ALGOFLON® or HOSTAFLON® or FLUON®).

According to another possible implementation, the junction connector may be so designed as to comprise only the substantially discoid (flange-like) body suitable for being coupled to a terminal tract of the outer conductor. From each one of the flat faces of the discoid body of the connector, intended to be coupled to a section of the rigid line, a distinct connection element extends which is adapted to be coupled to the corresponding end of the inner conductor of the rigid line, said connection element comprising a substantially tubular portion associated with a plurality of elastic tabs. In this case as well, the discoid connector allows the connection element to be positioned coaxially within the connector, and the inner conductor to be insulated from the outer conductor. In addition, the discoid body is preferably made of plastic material, e.g., polytetrafluoroethylene (also known as “PTFE”, i.e., a polymer of tetrafluoroethylene commercially known as TEFLON® or ALGOFLON® or HOSTAFLON® or FLUON®), and the two outer conductors of two transmission lines are coupled by contact to the discoid element or body.

It is therefore clear that the connectors known in the art, in addition to allowing the inner conductors of different sections to be joined together, also allow the inner conductor to be coaxially positioned inside said outer conductor and to be insulated from the outer conductor.

In particular, the connection element and the inner conductor are coupled to each other by inserting the connection element into the end of the inner conductor, this insertion being typically achieved through a substantially linear movement; during this movement, the elastic tabs of the connection element are forced to bend (so as to facilitate the insertion of said connection element into the end of the inner conductor) and then flex towards the inner surface of said inner conductor, thus establishing an optimal connection between the two components.

It is therefore apparent that said connection element is so designed as to ensure both elasticity, due to the non-continuous profile obtained by means of the plurality of elastic tabs, and adequate tightness, due to the fact that the diameter of the connection element is slightly smaller than that of the inner conductor.

According to the principles of physics on which signal or energy transmission over rigid lines is based, for each frequency to be used there is a maximum limit to the diameter of the conductors that can be used for making a transmission line. According to a known law of physics, in fact, as the frequency of a signal grows, its wavelength decreases. It is necessary that the wavelength value does not become too small in comparison with the difference in the radii of the two (inner and outer) conductors.

When a signal having a voltage V and a frequency f is applied to one end of the inner conductor, a current I is made to flow along said inner conductor. Said current I is surrounded by a magnetic field B which, as it reaches the outer conductor, induces therein an induced current opposite to the cause that generated it. If the difference between the diameters of the inner conductor and outer conductor is small, the current induced in the outer conductor will be offset by 180° relative to the current flowing along the inner conductor. Equal and opposite currents cancel each other out and produce no radiation. The above does not occur when such high frequencies are reached that reduce the ratio between the wavelength of the applied signal and the difference between the radii of the two conductors. In fact, some time must pass before the field B generated by the current in the central conductor arrives at the outer conductor and induces current therein. When such time becomes significant compared with the period of the applied signal, then the current induced in the outer conductor will no longer be offset by 180° relative to the current in the inner conductor, so that it will not be able to compensate for the effects thereof. Therefore, the wave will travel transversally as opposed to longitudinally, and different modes of propagation may be triggered. In a transmission line this will result, in practice, in strong attenuation of the transmitted signal.

As frequency grows, therefore, precise conductor sizes have been established which must not be exceeded.

It emerges from the above description that, in the solutions known in the art, for any given frequency there is a precise upper limit to the sizes of the inner and outer conductors. As a consequence, a limit also applies to the size of the connection element to be inserted into one end of said inner conductor. However, as said size becomes smaller, also the maximum power that can be carried through the junction decreases, due to problems of localized overheating caused by, among other things, the so-called “Joule effect”. Therefore, the design of the solutions currently known in the art necessarily implies a limitation of the transmissible power as a function of the frequency, which in turn limits the maximum size of the conductors. Said limitation of the transmissible power is not due to the fact that the ordinary sections of the transmission line cannot carry the power being considered, but to the necessity for preventing any potential junction overheating; exceeding this upper limit will lead to destruction of the junction itself or of an adjacent tract of the rigid transmission line.

### SUMMARY OF THE INVENTION

In this frame, it is the main object of the present invention to provide a transmission line, in particular of the rigid type and for a radiofrequency power application, which is so designed as to allow overcoming the drawbacks of prior-art transmission lines.

In particular, it is one object of the present invention to provide a transmission line, in particular of the rigid type and for a radiofrequency power application, which is so designed as to increase the transmissible power while preventing the junction of said transmission line from suffering from potential overheating.

It is another object of the present invention to provide a transmission line, in particular of the rigid type and for a radiofrequency power application, which is so designed as to include a connection element that can ensure both elasticity and adequate tightness.

It is a further object of the present invention to provide a transmission line, in particular of the rigid type and for a radiofrequency power application, which is so conceived as to be able to effectively dissipate the generated heat, in particular the heat generated at a junction of said transmission line following an increase in transmitted power in excess of the maximum value considered to be admissible for transmission lines made in accordance with the prior art.

Said objects are achieved by the present invention through a transmission line, in particular of the rigid type and for a radiofrequency power application, incorporating the features set out in the appended claims, which are an integral part of the present description.

### BRIEF DESCRIPTION OF THE DRAWINGS

Further objects, features and advantages of the present invention will become apparent from the following detailed description and from the annexed drawings, which are supplied by way of non-limiting explanatory example, wherein:

FIG. 1 is a perspective view of a transmission line, in particular of the rigid type and for a radiofrequency power application, according to the present invention;

FIG. 2 is a longitudinal sectional view of the transmission line of FIG. 1;

FIG. 3 is a longitudinal sectional view of a first variant of the transmission line according to the present invention;

FIG. 4 is a longitudinal sectional view of a second variant of the transmission line according to the present invention.

### DETAILED DESCRIPTION OF THE PREFERRED EMBODIMENTS

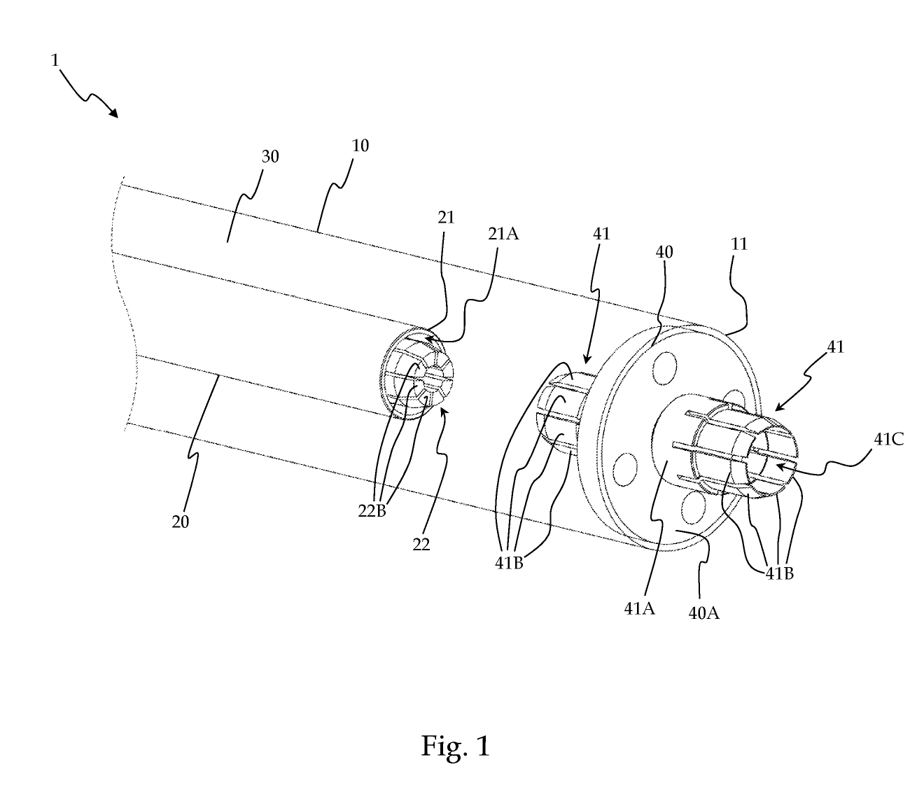

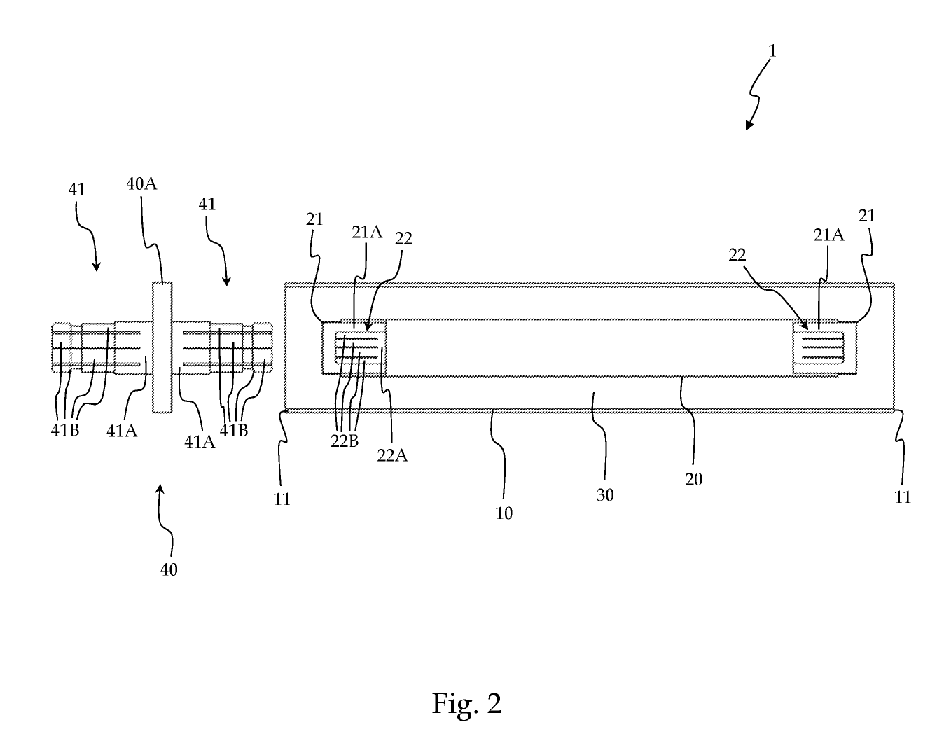

The annexed FIGS. 1 and 2 will now be described, wherein reference numeral 1 designates as a whole a transmission line, in particular of the rigid type and for a radiofrequency power application, in accordance with the present invention.

The transmission line 1 comprises, as is known in the art, a first conductor 10 (which can be defined as “outer conductor”) having a tubular shape, a second conductor 20 (which can be defined as “inner conductor”), concentrically and coaxially positioned inside said first conductor 10, and a dielectric 30 positioned between the first conductor 10 and the second conductor 20.

As is known, the first conductor 10 and the second conductor 20 are made of a material (e.g., copper or aluminium) having a very low resistivity value, whereas said dielectric 30 preferably consists of air; this provision allows for fast assembly of the rigid transmission line 1 in the place where the system is located, without incurring the typical risks deriving from the use of a dielectric consisting of gas.

It should be noted that in FIG. 1 the first conductor 10 is represented as if it were transparent; however, such a representation of the first conductor 10 is merely aimed at showing the components that are present inside.

The transmission line 1 further comprises a connector (designated as a whole by reference numeral 40 in the annexed drawings) equipped with a body 40A adapted to be coupled to a terminal tract 11 of the first conductor 10.

In the embodiment shown in the annexed drawings, the body 40A has a substantially discoid shape suitable for being coupled to a terminal tract 11 of the first conductor 10. In particular, as can be observed in FIG. 1, the body 40A is at least partially inserted into said terminal tract 11 of the tubular first conductor 10, the dimensions of the body 40A being slightly smaller than the internal dimensions of the terminal tract 11 of said tubular first conductor 10; as a result, the body 40A of the connector 40 is secured by interference to the inner walls of the terminal tract 11 of said tubular first conductor 10. It is however clear that the coupling between the terminal tract 11 of the first conductor 10 and the body 40A of the connector 40 may also be different than shown in FIG. 1; merely by way of example, said coupling may be effected by screwing the body 40A of the connector into the terminal tract 11 of the first conductor 10.

Preferably, the body 40A of the connector 40 is made of non-conductive material, in particular plastic material (e.g., polytetrafluoroethylene, also known as “PTFE”).

The connector 40 comprises at least one first connection element (designated as a whole by reference numeral 41 in the annexed drawings) adapted to be inserted, at least partially, into a seat 21A formed in one end 21 of the second conductor 20, said at least one first connection element 41 comprising a substantially tubular first portion 41A from which a plurality of first elastic tabs 41B extend.

The first tabs 41B allow to confer an adequate elasticity to the first connection element 41, since they allow said connection element 41 to be realized with a non-continuous profile.

In a preferred embodiment, the portion 41A and/or each first tab 41B of the first connection element 41 have straight tracts joined by one or more curved tracts, so as to have one or more narrower sections adapted to facilitate the insertion of the first connection element 41 into said seat 21A formed in one end 21 of the second conductor 20.

It must be pointed out that the second conductor 20 may consist of either a tubular element or a solid bar. In the former case (i.e., when the second conductor 20 consists of a tubular element), the seat 21A substantially corresponds to the final tract of the tubular element; in the latter case (i.e., when the second conductor 20 consists of a solid bar), the seat 21A is formed or milled in the end 21 of the second conductor 20.

Preferably, the connector 40 comprises a pair of first connection elements 41 extending in opposite directions from the body 40A of the connector 40 (in particular, said pair of first connection elements 41 extend in opposite directions from each one of the substantially flat faces of the body 40A having a substantially discoid shape, as shown in the annexed drawings), so that each one of the first connection elements 41 can fit into respective seats 21A formed in the ends 21 of two different second conductors 20 belonging to two different sections of a transmission line 1; it should be noted that said pair of first connection elements 41 may also be made as one piece, particularly by making a single tubular portion 41A from which the first tabs 41B extend in opposite directions.

In accordance with another embodiment (not shown in the annexed drawings), the connector 40 can be realized to include a casing (not shown in the annexed drawings) having a substantially cylindrical (sleeve-like) shape, in particular made of metallic material, wherein said casing encloses the body 40A (which can also be defined as spacer or rigid centralizer, since it performs such functions), which allows at least one first connection element 41 to be coaxially positioned and insulated inside the substantially cylindrical body and said at least one first connection element 41. It should be noted that also in this embodiment the body 40A is made of non-conductive material, in particular plastic material (e.g., polytetrafluoroethylene, also known as “PTFE”).

In this embodiment as well, the connector 40 comprises at least one first connection element 41 adapted to be inserted, at least partially, into the seat 21A formed in the end 21 of the second conductor 20, in particular said at least one first connection element 41 comprising a substantially tubular first portion 41A from which a plurality of first elastic tabs 41B extend.

Furthermore, in this embodiment the substantially cylindrical casing of the connector 40 is at least partially slipped over the outside of the terminal tract 11 of the tubular first conductor 10, the dimensions of said casing being slightly greater than the outer dimensions of the terminal tract 11 of said tubular first conductor 10.

In accordance with the present invention, the second conductor 20 comprises a second connection element 22 at least partially positioned in said seat 21A, said second connection element 22 being adapted to be coupled to the first connection element 41 by inserting it into a cavity 41C of said first connection element 41; in particular, the shape of said cavity 41C is substantially tubular.

Preferably, the second connection element 22 has a shape substantially corresponding to that of the first connection element 41 and smaller dimensions than said first connection element 41, so that it can be inserted into the cavity 41C (which is substantially tubular in shape) of the first connection element 41 with optimal contact between the two components.

In particular, the second connection element 22 comprises a substantially tubular tract 22A from which a plurality of second tabs 22B extend.

The second tabs 22B confer adequate elasticity on the second connection element 22, since they allow said second connection element 22 to be realized with a non-continuous profile.

Furthermore, also the tract 22 and/or each second tab 22B has/have straight tracts joined by one or more curved tracts, so that said second connection element 22A comprises one or more narrower sections that facilitate the insertion of the second connection element 22 (in particular, the second tabs 22B and the tract 22A) into said cavity 41C of the first connection element 41.

It should be noted that, in FIGS. 2 to 4, the second conductor 20 is represented as having both ends 21 so realized as to comprise a respective second connection element 22 made in accordance with the provisions of the present invention; it is however clear that the second conductor 20 may alternatively have only one of the two ends 21 realized to include said second connection element 22.

Furthermore, as previously specified, the second conductor 20 may consist of either a tubular element or a solid bar. In the former case (second conductor 20 consisting of a tubular element), the second connection element 22 may consist of a separate element that can be at least partially inserted into the seat 21A of the second conductor 20, wherein said seat 21A substantially corresponds to the final tract of the tubular element. In the latter case (second conductor 20 consisting of a solid bar), the seat 21A and the second connection element 22 may be made either as described above or by appropriately machining the end 21 of the second conductor 20; in substance, when the second conductor 20 is a solid bar, the seat 21A and the second connection element 22 may also be substantially formed in the end 21 of the second conductor 20.

The special provision of the second connection element 22 according to the present invention allows realizing a transmission line 1, in particular of the rigid type and for a radiofrequency power application, in such a way as to allow overcoming the drawbacks of prior-art transmission lines.

In particular, the second connection element 22 allows realizing the transmission line 1 in such a way as to make it possible to increase the transmissible power as a function of frequency, and hence of the maximum sizes of the conductors, while at the same time preventing the junction of said transmission line from suffering from potential overheating, since said second connection element 22 ensures effective dissipation of the heat generated in the transmission line 1 following an increase in transmissible power, the dimensions being equal, in particular of the heat generated at a junction of said transmission line 1.

This is made possible by the fact that the provision of the second connection element 22 allows for a significant increase in the contact surface between the first connection element 41 and the second conductor 20; in fact, due to the provision of the second connection element 22, the first connection element 41 is in contact with the inner walls of the seat 21A and also with the outer walls of said second connection element 22 (in particular, with the outer walls of the second tabs 22B).

It is therefore clear that the provision of the second connection element 22 according to the present invention allows decreasing the size of the second conductor 20 and of the first connection element 41 (which must be inserted into the seat 21A) in order to increase the frequency and transmissible power, while at the same time avoiding the junction overheating problems that are known to be suffered by the prior art.

It follows that the provisions of the present invention turn out particularly useful and valuable for transmission lines 1 intended for high-power applications, e.g., in the radio-television broadcasting field.

In a preferred embodiment, the second connection element 22 comprises a thrust element (not shown in the annexed drawings, since said thrust element is preferably positioned within the space defined by the second tabs 22B of the second connection element 22) adapted to expand as the first connection element 41 and the second conductor 20 are coupled together; as a consequence, said thrust element allows exerting more pressure from within the second connection element 22, which will then press against the first connection element 41, which in turn will exert more pressure on the inner walls of the seat 21A.

For example, said thrust element may consist of an element having a substantially truncated-cone shape, which, in an idle condition, is partially inserted in the second connection element 22 with its major base facing towards the first connection element 41. When the second conductor 20 is abutted on and pressed against the first connection element 41 in order to effect the installation, the major base of the truncated cone abuts on the inside of the first connection element 41; as the pressure necessary for causing the second conductor 20 (inner conductor) to come in abutment is exerted, the truncated cone will translate in the second connection element 22, thereby exerting pressure from within and improving the contact between the second tabs 22B of the second connection element 22 and the first connection element 41.

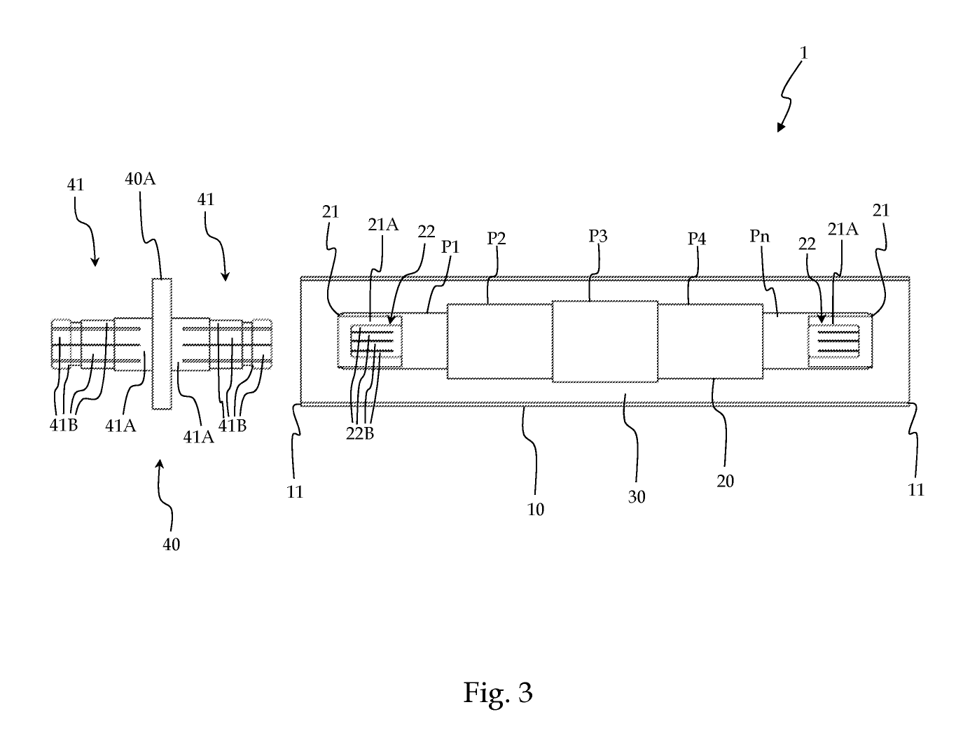

FIG. 3 shows a longitudinal sectional view of a first variant of the transmission line 1 according to the present invention.

In accordance with said first variant, the second conductor 20 has a variable profile along its longitudinal development, so as to constitute an impedance transformer.

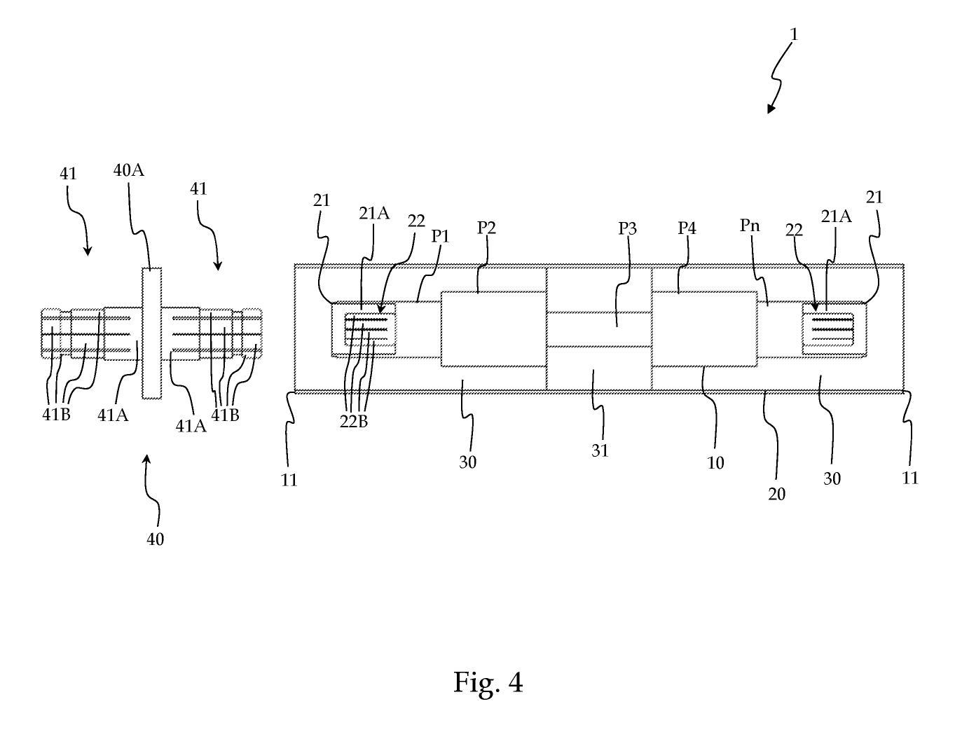

In particular, said variable profile is obtained by means of a second conductor 20 comprising at least two portions (in FIGS. 3 and 4, references P1, P2, P3, P4, Pn designate a plurality of said portions) having different outside diameters in a cross-sectional view relative to the longitudinal development of said first conductor 10 and second conductor 20; it should be noted that, in this variant, the outside diameter of the ends 21 of the second conductor 20 is such as to allow obtaining an impedance equal to the nominal one of the transmission line 1.

FIG. 4 shows a longitudinal sectional view of a second variant of the transmission line 1 according to the present invention.

In accordance with this second variant, the transmission line 1 comprises at least one tract of a second dielectric 31 made of a different material than the dielectric 30 positioned between the first conductor 10 and the second conductor, in particular said second dielectric 31 being of the solid type and/or being made of a material having a higher thermal exchange coefficient than the dielectric 30 (which typically consists of air).

In such an embodiment, the tract of the second conductor 20 that is surrounded by the solid second dielectric 31 (said tract being, in the representation of FIG. 4, the one designated by reference P3) is so sized as to have a lower impedance than the contiguous tracts (said contiguous tracts being, in the representation of FIG. 4, the ones designated by references P2 and P4) of the second conductor 20 that are in contact with the dielectric 30, in particular consisting of air.

In a preferred embodiment, said solid second dielectric 31 is made of aluminium nitride (AlN); it is however clear that the material of said solid dielectric 31 may be different as well.

Furthermore, in the variant embodiment shown in FIG. 4 the outer surface of the first conductor 10 positioned near the solid dielectric 31 may be associated with a cooling system (not shown) for dissipating the heat coming from said solid dielectric 31; for example, said cooling system may consist of a passive radiator (e.g., fins associated with or formed on said outer surface of the first conductor 10), or a Peltier cell, or an active cooling system (e.g., cold water tubes), and so on.

The features of the present invention, as well as the advantages thereof, are apparent from the above description.

The particular provision of the second connection element 22 according to the present invention allows realizing a transmission line 1, in particular of the rigid type and for a radiofrequency power application, in such a way as to allow overcoming the drawbacks of prior-art transmission lines.

The second connection element 22 allows realizing the transmission line 1 in such way as to make it possible to increase the transmissible power as a function of frequency, and hence of the maximum size usable for the second conductor 20 (inner conductor) and for the first conductor 10 (outer conductor), while at the same time preventing the junction of said transmission line from suffering from potential overheating, since said second connection element 22 ensures effective dissipation of the heat generated in the transmission line 1 following an increase in transmissible power as a function of frequency, in particular of the heat generated at a junction of said transmission line 1.

In fact, the provision of the second connection element 22 allows for a significant increase in the contact surface between the first connection element 41 and the second conductor 20, since the first connection element 41 remains in contact with the inner walls of the seat 21A and also with the outer walls of said second connection element 22 (in particular, with the outer walls of the second tabs 22B).

It is therefore clear that the provision of the second connection element 22 according to the present invention allows decreasing the cross-section of the considered transmission line 1, with the maximum transmissible power being equal, in that it is possible to reduce the sizes of the second conductor 20 and of the first connection element 41 (which must be inserted into the seat 21A), thus also reducing, according to the known laws of physics, the size of the first conductor 10 (outer conductor). Moreover, the dimensions being equal, the maximum transmissible power can be increased while avoiding the junction overheating problems suffered by the prior art.

The realization of the transmission line 1 including a tract of solid dielectric 31 made of a material having a higher thermal exchange coefficient than that of the dielectric 30 consisting of air significantly contributes to reducing the above-mentioned overheating problems, thereby also contributing to reducing the sizes of the second conductor 20 and of the first connection element 41, which reduced sizes allow for an increase in frequency and transmissible power.

In addition, the fact that the second conductor 20 is realized with a variable profile along its longitudinal development allows realizing an impedance transformer useful for allowing the insertion of a solid dielectric having a relative dielectric constant greater than 1 while still using a diameter of the second conductor 20 (inner conductor) that ensures adequate thermal exchange, adequate mechanical strength and a favourable behaviour towards the flowing currents. Said solid dielectric can remove a considerable amount of heat from the second conductor 20 and transfer said removed heat to the first conductor 10, which, unlike the second conductor 20, can be easily cooled by means of passive and/or active systems; all this contributes to increasing the power transmissible over the transmission line 1.

It is therefore clear that the provisions of the present invention turn out to be particularly useful and valuable for transmission lines 1 intended for high-power and high-frequency applications.

The transmission line described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described transmission line, but may be subject to many modifications, improvements or replacements of equivalent parts and elements without departing from the inventive idea, as clearly specified in the following claims.

1. A transmission line, in particular of the rigid type and for a radiofrequency power application, of the type that comprises:
a first conductor having a tubular shape,
a second conductor, concentrically and coaxially positioned inside said first conductor,
a dielectric, in particular consisting of air, positioned between the first conductor and the second conductor,
a connector having a body adapted to be coupled to a terminal tract of the first conductor, wherein said connector comprises at least one first connection element adapted to be inserted, at least partially, into a seat formed in one end of the second conductor, in particular said at least one first connection element comprising a substantially tubular first portion from which a plurality of first elastic tabs extend,
wherein said second conductor comprises a second connection element at least partially positioned in said seat, said second connection element being adapted to be coupled to the first connection element by inserting it into a cavity of said first connection element.

2. The transmission line according to claim 1, wherein the second connection element has a shape substantially corresponding to the shape of the first connection element and is smaller than said first connection element.

3. The transmission line according to claim 1, wherein the second connection element comprises a substantially tubular tract from which a plurality of second tabs extend.

4. The transmission line according to claim 3, wherein the tract and/or each second tab has/have straight tracts joined by one or more curved tracts, so that said second connection element comprises one or more narrower sections that facilitate the insertion thereof into said cavity of the first connection element.

5. The transmission line according to claim 1, wherein the second conductor consists of a tubular element and the second connection element consists of a separate element that can be at least partially inserted into the seat of the second conductor, wherein said seat (21A) substantially corresponds to the final tract of the tubular element.

6. The transmission line according to claim 1, wherein second conductor consists of a solid bar, said seat and said connection element being made by machining the end of the second conductor.

7. The transmission line according to claim 1, wherein the second connection element comprises a thrust element adapted to expand when the first connection element is coupled to the second conductor, in order to allow exerting more pressure, from within the second connection element, on the first connection element and on the inner walls of the seat.

8. The transmission line according to claim 1, wherein the second conductor has a variable profile along its longitudinal development, so as to constitute an impedance transformer.

9. The transmission line according to claim 8, wherein the variable profile is obtained by means of a second conductor comprising at least two portions having different outside diameters in a cross-sectional view relative to the longitudinal development of said first conductor and second conductor.

10. The transmission line according to claim 9, wherein the outside diameter of the ends of the second conductor is such as to allow obtaining an impedance equal to the nominal one.

11. The transmission line according to claim 1, wherein it comprises at least one tract of a second dielectric made of a different material than the dielectric positioned between the first conductor and the second conductor, in particular said second dielectric being of the solid type and/or being made of a material having a higher thermal exchange coefficient than the dielectric.

12. The transmission line according to claim 11, wherein the tract of the second conductor surrounded by said solid second dielectric is so sized as to have a different impedance than the contiguous tracts of the second conductor in contact with the dielectric.

13. The transmission line according to claim 11, wherein the solid second dielectric is made of aluminium nitride.

14. The transmission line according to claim 1, wherein the portion and/or each first tab of the first connection element have straight tracts joined by one or more curved tracts, so as to have one or more narrower sections adapted to facilitate the insertion of the first connection element into said seat formed in one end of the second conductor.

15. Transmission The transmission line according to claim 1, wherein the body of the connector has a substantially discoid shape and is at least partially inserted into said terminal tract of the tubular first conductor the dimensions of the body being slightly smaller than the internal dimensions of the terminal tract of said tubular first conductor.

16. The transmission line according to claim 15, wherein the connector comprises a substantially cylindrical casing that encloses the body, said casing covering at least partially said terminal tract of the tubular first conductor, the dimensions of said casing of the body being slightly greater than the external dimensions of the terminal tract of said tubular first conductor.
